(19) United States
(12) Patent Application Publication
(10) Pub. No.: US 2024/0413500 A1
(43) Pub. Date: Dec. 12, 2024

(54) ENERGY STORAGE DEVICE

(71) Applicant: GS Yuasa International Ltd., Kyoto-shi (JP)

(72) Inventors: Hironori AIDA, Kyoto-shi (JP); Ryoichi OKUYAMA, Kyoto-shi (JP)

(73) Assignee: GS Yuasa International Ltd., Kyoto-shi (JP)

(21) Appl. No.: 18/699,515

(22) PCT Filed: Oct. 12, 2022
(86) PCT No.: PCT/JP2022/037960

§ 371 Date: Apr. 8, 2024

(30) Foreign Application Priority Data
Oct. 13, 2021 (JP) 2021-168402

(51) Int. Cl. H01M 50/564; H01G 11/74; H01G 11/78; H01M 10/04; H01M 50/105; H01M 50/538; H01M 50/547

(52) U.S. Cl. CPC H01M 50/564; H01M 10/0431; H01M 50/105; H01M 50/538; H01M 50/547; H01G 11/74; H01G 11/78

(57) ABSTRACT

An energy storage device includes: an electrode assembly that is formed by stacking a plurality of plates and is elongated in a first direction; a container that accommodates the electrode assembly and is elongated in the first direction; and a first terminal that is electrically connected to the electrode assembly. The container includes a side surface portion at an end portion of the container in the first direction. The side surface portion includes: a first terminal mounting portion on which the first terminal is mounted; and a first recessed portion that is formed at a position different from a position where the first terminal mounting portion is disposed.

### TECHNICAL FIELD

The present invention relates to an energy storage device that includes an electrode assembly.

### BACKGROUND ART

Conventionally, there has been known an energy storage device where a pair of terminals (a negative electrode output terminal and a positive electrode terminal) is mounted on a lid body (lid) of a container that accommodates an electrode assembly in a state where the pair of terminals protrudes (see, for example, Patent Document 1).

### PRIOR ART DOCUMENT

### Patent Document

Patent Document 1: JP-A-2010-73580

### SUMMARY OF THE INVENTION

### Problems to be Solved by the Invention

There may be case where, around the energy storage device, a member other than the energy storage device such as a wire for measuring a voltage or a temperature is disposed. In this case, the member is disposed outside a container of the energy of the energy storage device. Accordingly, there is a concern that a space outside the energy storage device is wastefully used and hence, space utilization efficiency is lowered.

In view of the above, it is an object of the present invention to provide an energy storage device that can suppress the lowering of space utilization efficiency outside the energy storage device.

### Means for Solving the Problems

To achieve the above-mentioned object, an energy storage device according to the present invention includes: an electrode assembly that is formed by stacking a plurality of plates and is elongated in a first direction; a container that accommodates the electrode assembly and is elongated in the first direction; and a first terminal that is electrically connected to the electrode assembly, in which the container includes a side surface portion at an end portion of the container in the first direction, and the side surface portion includes: a first terminal mounting portion on which the first terminal is mounted; and a first recessed portion that is formed at a position different from a position where the first terminal mounting portion is disposed.

### Advantages of the Invention

According to the present invention, it is possible to provide an energy storage device that can suppress the lowering of the space utilization efficiency outside an energy storage device.

### BRIEF DESCRIPTION OF THE DRAWINGS

FIG. 1 is a perspective view illustrating an external appearance of an energy storage device according to an embodiment 1.

FIG. 2 is an exploded perspective view of the energy storage device according to the embodiment 1 illustrating respective constitutional elements in a state where the energy storage device is disassembled.

FIG. 3 is a perspective view illustrating the configuration of an electrode assembly according to the embodiment 1.

FIG. 4 is a plan view illustrating a first side surface portion according to the embodiment 1.

FIG. 5 is a plan view schematically illustrating an energy storage device according to a comparative example.

FIG. 6 is an explanatory view illustrating a state where a wire for measuring a voltage is mounted in a first recessed portion according to the embodiment 1.

FIG. 7 is a plan view illustrating a first side surface portion according a modification 1 of the embodiment 1.

FIG. 8 is a plan view illustrating a first side surface portion according a modification 2 of the embodiment 1.

FIG. 9 is a plan view illustrating a first side surface portion according a modification 3 of the embodiment 1.

FIG. 10 is a top plan view illustrating a top plan view illustrating a first side surface portion according to a modification 4 of the embodiment 1.

FIG. 11 is an explanatory view illustrating rough positions of the first side surface portion, a second side surface portion, the first recessed portion, and a second recessed portion according to the embodiment 1.

FIG. 12 is a perspective view illustrating an external appearance of an energy storage device according to an embodiment 2.

FIG. 13 is an exploded perspective view of the energy storage device according to the embodiment 2 illustrating respective constituent elements in a state where the energy storage device is disassembled.

FIG. 14 is a schematic plan view of an energy storage device according to an embodiment 3.

### MODE FOR CARRYING OUT THE INVENTION

(1) An energy storage device according to an aspect of the present invention includes: an electrode assembly that is formed by stacking a plurality of plates and elongated in a first direction; a container that accommodates the electrode assembly and is elongated in the first direction; and a first terminal that is electrically connected to the electrode assembly, in which the container includes a side surface portion at an end portion of the container in the first direction, and the side surface portion includes: a first terminal mounting portion on which the first terminal is mounted; and a first recessed portion that is formed at a position different from a position where the first terminal mounting portion is disposed.

According to the energy storage device according to an aspect of the present invention, on the side surface portion of the container, the first recessed portion is formed at a position different from a position where the first terminal mounting portion is disposed. Accordingly, a member other than the energy storage device (a wire for measuring a voltage or a temperature or the like) can be disposed in the first recessed portion. With such a configuration, it is possible to suppress the member other than the energy storage device from protruding to the outside of the container and hence, it is possible to suppress the lowering of the space utilization efficiency outside the energy storage device.

(2) In the energy storage device according to the above-mentioned (1), the side surface portion may be elongated in a second direction that intersects with the first direction, the first terminal mounting portion may be disposed at one end portion of the side surface portion in the second direction, and the first recessed portion may be disposed at an other end portion of the side surface portion in the second direction.

According to the energy storage device described in the above-mentioned (2), the first terminal mounting portion is disposed at one end portion of the side surface portion and hence, a conductive member such as a bus bar can be easily joined to the first terminal on the first terminal mounting portion from the second direction. On the other hand, the first recessed portion is disposed on the other end portion of the side surface portion in the second direction. Accordingly, the first recessed portion can be formed in a shape where one end portion of the first recessed portion in the second direction is opened. Accordingly, the open region of the first recessed portion expands and hence, members other than the energy storage device can be easily disposed in the first recessed portion. In this manner, workability with respect to members around the energy storage device can be enhanced.

(3) In the energy storage device according to the above-mentioned (1) or (2), the first terminal mounting portion may be disposed in a second recessed portion formed at a position different from a position where the first recessed portion is disposed on the side surface portion.

According to the energy storage device described in the above-mentioned (3), the first terminal mounting portion is disposed in the second recessed portion formed on the side surface portion, at least a portion of the first terminal can be disposed in the second recessed portion. Accordingly, it is possible to reduce an energy storage device accommodating space (a space necessary for accommodating the energy storage device) outside the container.

(4) In the energy storage device according to any one of the above-mentioned (1) to (3), the energy storage device may include a second terminal that is electrically connected to the electrode assembly, and a second terminal mounting portion on which the second terminal is mounted may be disposed in the first recessed portion.

According to the energy storage device described in the above-mentioned (4), the second terminal mounting portion is disposed in the first recessed portion formed on the side surface portion and hence, at least a portion of the second terminal can be disposed in the first recessed portion. With such a configuration, the energy storage device accommodating space outside the container can be reduced.

(5) In the energy storage device according to the above-mentioned (4), the first terminal and the second terminal disposed on the side surface portion may have different polarities.

For example, assume a case where, in an electrode assembly that is elongated in the first direction, a positive electrode terminal is disposed only at one end portion of the electrode assembly in the first direction, and a negative electrode terminal is disposed only at the other end portion of the electrode assembly in the first direction. In this case, a distance between the positive electrode terminal and the negative electrode terminal becomes extremely long. Such a configuration induces the increase of an electric resistance and the occurrence of irregularities in reaction. In the energy storage device described in the above-mentioned (5), the longitudinal direction of the side surface portion of the container is shorter than the length of the electrode assembly in the first direction. Accordingly, even in a case where the first terminal and the second terminal having different polarities are disposed on the side surface portion, the distance between the terminals can be shortened. That is, in this mode, the distance between the first terminal and the second terminal having different polarities can be shortened and hence, the increase in electric resistance and the occurrence of irregularities in reaction can be suppressed.

(6) In the energy storage device described in any one of the above-mentioned (1) to (5), the electrode assembly may include an electrode assembly body and a pair of connecting portions which protrudes from one end portion of the electrode assembly body in the first direction, and the pair of connecting portions may be disposed within the side surface portion.

According to the energy storage device described in the above-mentioned (6), the pair of the connecting portions is disposed within the side surface portion. As a result, the electrode assembly body can be formed as large as possible in the inside of the container. The electrode assembly body is a portion that contributes to the storage of energy (the generation of power) and hence, if the portion can be formed with a large size, the electric capacitance can be increased.

An energy storage device according to another aspect of the present invention includes: an electrode assembly that is formed by stacking a plurality of plates and is elongated in a first direction; a container that accommodates the electrode assembly and is elongated in the first direction; and a pair of first terminals that is electrically connected to the electrode assembly, in which a first terminal mounting portion on which the first terminal is mounted and a first recessed portion that is formed at a position different from a position where the first terminal mounting portion is disposed are formed on each of a pair of side surface portions of the container, the pair of side surface portions facing each other in the first direction.

According to the energy storage device of another aspect of the present invention, on the side surface portion of the container, the first recessed portion is formed at the position different from the position where the first terminal mounting portion is disposed. Accordingly, a member other than the energy storage device (a wire for measuring a voltage or a temperature or the like) can be disposed in the first recessed portion. With such a configuration, it is possible to suppress the member other than the energy storage device from protruding to the outside of the container and hence, it is possible to suppress the lowering of the space utilization efficiency outside the energy storage device.

### EMBODIMENTS

Hereinafter, energy storage devices according to the embodiments (including modifications of the embodiments) of the present invention are described with reference to the drawings. All embodiments described hereinafter are comprehensive examples or specific examples of the present invention. Numerical values, shapes, materials, constitutional elements, arrangement positions and connection modes of the constitutional elements, manufacturing steps, the order of the manufacturing steps, and the like in the following exemplary embodiment are provided as examples, and are not intended to limit the present invention. In the respective drawings, sizes and the like are not strictly illustrated. In the respective drawings, identical or substantially identical constitutional elements are given the same symbols.

In the following description and drawings, a direction extending along a winding axis of an electrode assembly, a direction along which the electrode assembly extends, or a direction along which a pair of short-side surfaces of a container faces each other is defined as an X-axis direction. A direction along which a pair of long-side surfaces of the container faces each other or a thickness direction of the container is defined as a Y-axis direction. A direction along which a bottom surface of a container body of the container and a top surface of a lid body are arranged or a vertical direction is defined as a Z-axis direction. The X-axis direction is an example of the first direction, and the Z-axis direction is an example of the second direction. These X-axis direction, Y-axis direction, and Z-axis direction are the directions that intersect with each other (orthogonal to each other in the present embodiments). There may be a case where the Z-axis direction is not equal to the vertical direction depending on a use mode. However, in the description made hereinafter, for the sake of convenience of the description, the description is made by assuming the Z-axis direction as the vertical direction.

In the description made hereinafter, an X-axis positive direction indicates an arrow direction of an X-axis, and an X-axis negative direction indicates a direction opposite to the X-axis positive direction. The same goes for the Y-axis direction and the Z-axis direction. Expressions indicating the relative directions or the relative postures such as “parallel” or “orthogonal” also include cases where such directions or postures are not taken in a strict meaning of the terms. For example, a state where two directions are orthogonal to each other means not only a state where these two directions are completely orthogonal to each other but also a state where these two directions are substantially orthogonal to each other, that is, for example, a state where these two directions are orthogonal to each other with slight deviation of approximately several percent.

### Embodiment 1

### 1 Description of Overall Configuration of Energy Storage Device

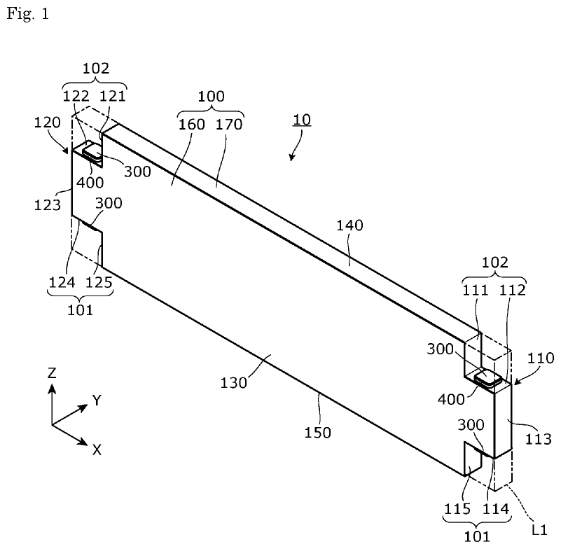

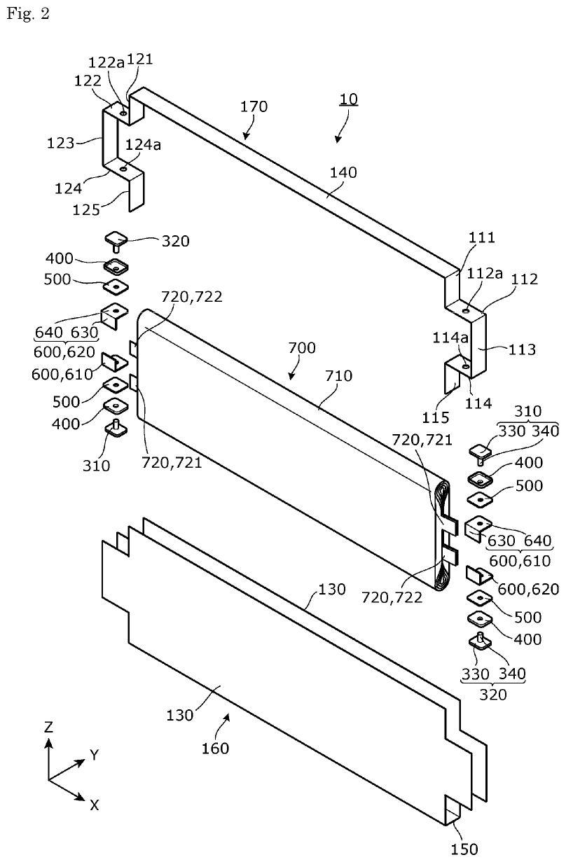

First, the overall configuration of an energy storage device 10 according to an embodiment 1 will be described with reference to FIG. 1 and FIG. 2. FIG. 1 is a perspective view illustrating an external appearance of the energy storage device 10 according to the embodiment 1. FIG. 2 is an exploded perspective view of the energy storage device 10 according to the embodiment 1 illustrating respective constitutional elements in a state where the energy storage device 10 is disassembled.

The energy storage device 10 is an energy storage device into which electricity can be charged from the outside and from which electricity can be discharged to the outside. In this embodiment, the energy storage device 10 has an approximately rectangular parallelepiped shape. For example, the energy storage device 10 is a battery used in an electricity storage application, a power source application, or the like. Specifically, the energy storage device 10 is used as a battery or the like for driving a mobile body such as an automobile, a motorcycle, a watercraft, a ship, a snowmobile, an agriculture machine, a construction machine, or a railway vehicle for an electric railway, or is used as a battery for starting an engine of the mobile body. As the above-described automobile, an electric vehicle (EV), a hybrid electric vehicle (HEV), a plug-in hybrid electric vehicle (PHEV), and an automobile that uses a fossils fuel (a gasoline, a light oil, a liquefied natural gas or the like) are exemplified. As an example of the railway vehicle for the electric railway described above, a train, a monorail, a linear motor car, and a hybrid train including both a diesel engine and an electric motor are exemplified. The energy storage device 10 can also be used as a stationary battery or the like used as a home-use battery, a business-use battery, or the like.

The energy storage device 10 is not limited to a non-aqueous electrolyte secondary battery. The energy storage device 10 may be a secondary battery other than the non-aqueous electrolyte secondary battery, or may be a capacitor. The energy storage device 10 is not necessarily a secondary battery, and may be a primary battery that allows a user to use stored electricity even when the user does not charge the energy storage device 10. The energy storage device 10 may be a battery that uses a solid electrolyte. The energy storage device 10 may be a pouch-type energy storage device. In this embodiment, the energy storage device 10 that has a flat rectangular parallelepiped shape (substantially rectangular parallelepiped shape) as a reference is illustrated. However, the shape of the energy storage device 10, that is, the shape of a container 100 is not limited to a shape that uses a rectangular parallelepiped shape as the reference, and may be a shape using a polygonal columnar shape other than a rectangular parallelepiped shape, that is, an elongated circular columnar shape, an elliptical columnar shape, a circular columnar shape, or the like as the reference.

As illustrated in FIG. 1 and FIG. 2, the energy storage device 10 includes: a container 100; two pairs of electrode terminals 300, and two pairs of outer gaskets 400. Two pairs of inner gaskets 500, two pairs of current collectors 600, and an electrode assembly 700 are accommodated in the container 100. Specifically, the respective members (a pair of electrode terminals 300, a pair of outer gaskets 400, a pair of inner gaskets 500, a pair of current collectors 600, and the like, the same understanding being adopted in the description made hereinafter) of the pair of electrodes (the positive electrode and the negative electrode) are disposed at one end portion of the container 100 in the X-axis positive direction. The respective members of the remaining pair of electrodes (the positive electrode and the negative electrode) are disposed at the other end portion of the container 100 in the X-axis negative direction. Specifically, on a first side surface portion 110 of the container 100 in the X-axis positive direction, the respective members of the positive electrode are disposed in the Z-axis positive direction, and the respective members of the negative electrode are disposed in the Z-axis negative direction. That is, the first side surface portion 110 is a range where the respective members of the positive electrode and the negative electrode in the X-axis positive direction are arranged from an end surface of the container 100 in the X-axis positive direction. For example, the first side surface portion 110 is a portion within a range of 1% to 10% of the length of the container 100 from the end surface of the container 100 in the X-axis positive direction with respect to the X-axis direction.

On a second side surface portion 120 of the container 100 in the X-axis negative direction, the respective members of the negative electrode are disposed in the Z-axis positive direction, and the respective members of the positive electrode are disposed in the Z-axis negative direction. That is, the second side surface portion 120 is a range where the respective members of the positive electrode and the negative electrode in the X-axis negative direction are arranged from an end surface of the container 100 in the X-axis negative direction. For example, the second side surface portion 120 is a portion within a range of 1% to 10% of the length of the container 100 from the end surface of the container 100 in the X-axis negative direction with respect to the X-axis direction.

With respect to the first side surface portion 110 of the container 100 and the second side surface portion 120 of the container 100, the respective members of the positive electrode and the respective members of the negative electrode are disposed in an inverted manner (in a vertically upside down manner) as viewed from a direction along the winding axis (as viewed in the X-axis direction).

Although an electrolytic solution (a non-aqueous electrolyte) is sealed in the container 100, the illustration of the electrolytic solution is omitted. A kind of the electrolyte solution is not particularly limited provided that the performance of the energy storage device 10 is not impaired, and various kinds of electrolyte solutions can be selected. Besides the constituent elements described above, the energy storage device 10 may further include: spacers that are disposed on the sides of the electrode assembly 700, above the electrode assembly 700, or below the electrode assembly 700; an insulating film that wraps the electrode assembly 700; and the like.

The container 100 is a case having a profile (a substantially rectangular parallelepiped shape) using a flat rectangular parallelepiped shape that is elongated in the X-axis direction as the reference. For example, a length of the container 100 in the X-axis direction is set 3 times or more as long as a length of the container 100 in the Z-axis direction. In FIG. 1, the rectangular parallelepiped shape that is used as the reference is indicated by a double-dashed chain line L1. Specifically, the container 100 has a profile where a rectangular cutout is formed on upper and lower portions of both end portions in the X-axis direction with respect to a flat rectangular parallelepiped shape elongated in the X-axis direction. It can also be said that each cutout forms a recessed portion as viewed in consideration of the rectangular parallelepiped shape used as the reference. With respect to the plurality of cutouts, the pair of cutouts positioned at the lower portion of the container 100 each forms a first recessed portion 101, and the pair of cutouts positioned at the upper portion of the container 100 each forms a second recessed portion 102. That is, on each of the first side surface portion 110 and the second side surface portion 120 of the container 100, the first recessed portion 101 and the second recessed portion 102 are formed at positions different from each other in the Z-axis direction so as to face each other in the Z-axis direction. An electrode terminal 300 is disposed in each of the first recessed portion 101 and the second recessed portion 102. Accordingly, in each of the first side surface portion 110 and the second side surface portion 120 of the container 100, (the entirety of) the electrode terminal 300 in the first recessed portion 101 and (the entirety of) the electrode terminal 300 in the second recessed portion 102 face each other in the Z-axis direction, and (the entirety of) the electrode terminal 300 in the second recessed portion 102 and (the entirety of) the electrode terminal 300 in the first recessed portion 101 face each other in the Z-axis direction.

FIG. 11 is an explanatory view illustrating rough positions of the first side surface portion 110, the second side surface portion 120, the first recessed portions 101, and the second recessed portions 102 according to the embodiment 1. In FIG. 11, the first side surface portion 110 and the second side surface portion 120 are surrounded by a broken line, and the first recessed portions 101 and the second recessed portions 102 are surrounded by a chain line.

As illustrated in FIG. 1 and FIG. 2, specifically, the first side surface portion 110 includes a first upper side surface 111, a first upper surface 112, a first intermediate side surface 113, a first lower surface 114, and a first lower side surface 115, and the first side surface portion 110 is elongated in the Z-axis direction as viewed in the X-axis direction. The first upper side surface 111 is disposed at an upper portion of the first side surface portion 110, and is a rectangular flat surface that is parallel to a YZ plane and is elongated in the Z-axis direction. The first upper surface 112 is a flat surface extending in the X-axis positive direction from a lower end of the first upper side surface 111, and is a rectangular flat surface that is parallel to the XY plane and is elongated in the X-axis direction. The first intermediate side surface 113 is a flat surface extending downward from an end portion of the first upper surface 112 in the X-axis positive direction, and is a rectangular flat surface that is parallel to the YZ plane and is elongated in the Z-axis direction. The first lower surface 114 is a flat surface extending in the X-axis negative direction from a lower end of the first intermediate side surface 113, and is a rectangular flat surface parallel to the XY plane and elongated in the X-axis direction. The first lower side surface 115 is a flat surface extending downward from an end portion of the first lower surface 114 in the X-axis negative direction, and is a rectangular flat surface that is parallel to the YZ plane and is elongated in the Z-axis direction.

The second recessed portion 102 of the first side surface portion 110 is defined by the first upper side surface 111 and the first upper surface 112, and an end portion of the second recessed portion 102 in the Z-axis positive direction and an end portion of the second recessed portion 102 in the X-axis positive direction are opened. The first recessed portion 101 of the first side surface portion 110 is defined by the first lower surface 114 and the first lower side surface 115, and an end portion of the first recessed portion 101 in the Z-axis negative direction and an end portion of the first recessed portion 101 in the X-axis positive direction are opened. Accordingly, the end portion of the first side surface portion 110 in the Z-axis positive direction (a corner portion of the container 100 in the X-axis positive direction and in the Z-axis positive direction) is formed in a shape where surfaces extending in the X-axis direction and the Z-axis direction are recessed and the shape penetrates in the Y-axis direction. On the other hand, also the end portion of the first side surface portion 110 in the Z-axis negative direction (a corner portion of the container 100 in the X-axis positive direction and in the Z-axis negative direction) is formed in a shape where surfaces extending in the X-axis direction and the Z-axis direction are recessed and the shape penetrates in the Y-axis direction. In other words, the second recessed portion 102 of the first side surface portion 110 is a recessed portion where a corner portion of the container 100 in the X-axis positive direction and in the Z-axis positive direction is recessed (cut out) in a quadrangular shape (L shape) as viewed in the Y-axis direction. The first recessed portion 101 of the first side surface portion 110 is a recessed portion where a corner portion of the container 100 in the X-axis positive direction and in the Z-axis negative direction is recessed (cut out) in a quadrangular shape (L shape) as viewed in the Y-axis direction.

The second side surface portion 120 includes a second upper side surface 121, a second upper surface 122, a second intermediate side surface 123, a second lower surface 124, and a second lower side surface 125, and the second side surface portion 120 is elongated in the Z-axis direction as viewed in the X-axis direction. The second upper side surface 121 is disposed at an upper portion of the second side surface portion 120, and the second upper side surface 121 is a rectangular flat surface that is parallel to the YZ plane and is elongated in the Z-axis direction. The second upper surface 122 is a flat surface extending in the X-axis negative direction from a lower end of the second upper side surface 121, and the second upper surface 122 is a rectangular flat surface that is parallel to the XY plane and is elongated in the X-axis direction. The second intermediate side surface 123 is a flat surface extending downward from an end portion of the second upper surface 122 in the X-axis negative direction, and the second intermediate side surface 123 is a rectangular flat surface that is parallel to the YZ plane and is elongated in the Z-axis direction. The second lower surface 124 is a flat surface extending in the X-axis positive direction from a lower end of the second intermediate side surface 123, and the second lower surface 124 is a rectangular flat surface that is parallel to the XY plane and is elongated in the X-axis direction. The second lower side surface 125 is a flat surface extending downward from an end portion of the second lower surface 124 in the X-axis negative direction, and the second lower side surface 125 is a rectangular flat surface that is parallel to the YZ plane and is elongated in the Z-axis direction.

The second recessed portion 102 of the second side surface portion 120 is defined by the second upper side surface 121 and the second upper surface 122, and an end portion of the second recessed portion 102 in the Z-axis positive direction and an end portion of the second recessed portion 102 in the X-axis negative direction are opened. The first recessed portion 101 of the second side surface portion 120 is defined by the second lower surface 124 and the second lower side surface 125, and an end portion of the first recessed portion 101 in the Z-axis negative direction and an end portion of the first recessed portion 101 in the X-axis negative direction are opened. Accordingly, the end portion of the second side surface portion 120 in the Z-axis positive direction (a corner portion of the container 100 in the X-axis negative direction and in the Z-axis positive direction) is formed in a shape where surfaces extending in the X-axis direction and the Z-axis direction are recessed and the shape penetrates in the Y-axis direction. On the other hand, the end portion of the second side surface portion 120 in the Z-axis negative direction (a corner portion of the container 100 in the X-axis negative direction and in the Z-axis negative direction) is formed in a shape where surfaces extending in the X-axis direction and the Z-axis direction are recessed and the shape penetrates in the Y-axis direction. In other words, the second recessed portion 102 of the second side surface portion 120 is a recessed portion where a corner portion of the container 100 in the X-axis negative direction and in the Z-axis positive direction is recessed (cut out) in a quadrangular shape as viewed in the Y-axis direction. The first recessed portion 101 of the second side surface portion 120 is a recessed portion where a corner portion of the container 100 in the X-axis negative direction and in the Z-axis negative direction is recessed (cut out) in a quadrangular shape as viewed in the Y-axis direction.

In the container 100, both end surfaces that face each other in the Y-axis direction each form the long side surface 130. Each long side surface 130 is a flat surface that is parallel to the XZ plane and is elongated in the X-axis direction, and both end portions of the long side surface 130 in the X-axis direction have shapes corresponding to the first side surface portion 110 and the second side surface portion 120.

With respect to both end surfaces of the container 100 that face each other in the Z-axis direction, the end surface in the Z-axis positive direction is a top surface 140, and the end surface in the Z-axis negative direction is a bottom surface 150. The top surface 140 is a rectangular flat surface that is parallel to the XY plane and is elongated in the X-axis direction. The top surface 140 connects an upper end of the first upper side surface 111 of the first side surface portion 110 and an upper end of the second upper side surface 121 of the second side surface portion 120 to each other. The bottom surface 150 is a rectangular flat surface that is parallel to the XY plane and is elongated in the X-axis direction. The bottom surface 150 connects the lower end of the first lower side surface 115 of the first side surface portion 110 and the lower end of the second lower side surface 125 of the second side surface portion 120 to each other.

The container 100 includes a container body 160 and a lid body 170, and is formed in a substantially rectangular parallelepiped shape by assembling the container body 160 and the lid body 170. The container body 160 has a pair of long side surfaces 130 and the bottom surface 150. The lid body 170 has the first upper side surface 111, the first upper surface 112, the first intermediate side surface 113, the first lower surface 114, the first lower side surface 115, the second upper side surface 121, the second upper surface 122, the second intermediate side surface 123, the second lower surface 124, the second lower side surface 125, and the top surface 140.

Specifically, the container body 160 is a substantially U-shaped sheet metal with an upper side thereof opened as viewed in the X-axis direction. The container body 160 has flat plate-shaped long side wall portions that form a pair of the long side surfaces 130 at both end portions thereof in the Y-axis direction. The container body 160 has a flat plate-shaped rectangular bottom wall portion that forms the bottom surface 150 at an end portion in the Z-axis negative direction.

The lid body 170 is a sheet metal with a lower side thereof opened as viewed in the Y-axis direction. The lid body 170 has a bent plate portion that forms the first upper side surface 111, the first upper surface 112, the first intermediate side surface 113, the first lower surface 114, and the first lower side surface 115 at an end portion in the X-axis positive direction. The lid body 170 has a bent plate portion that forms the second upper side surface 121, the second upper surface 122, the second intermediate side surface 123, the second lower surface 124, and the second lower side surface 125 at an end portion in the X-axis negative direction. The lid body 170 has a flat plate-shaped rectangular top wall portion that forms the top surface 140 at an end portion in the Z-axis positive direction.

With such a configuration, the container 100 has the structure where the inside of the container 100 is sealed. Such sealed structure is obtained by housing the electrode assembly 700 and the like in the container body 160 and, thereafter, by joining the container body 160 and the lid body 170 to each other by welding or the like. A material of the container 100 (the container body 160 and the lid body 170) is not particularly limited. However, for example, it is preferable that the container 100 be made of weldable metal such as stainless steel, aluminum, an aluminum alloy, iron, or a plated steel plate.

Although not illustrated in the drawings in this embodiment, a solution filling portion and a gas release valve are formed on the lid body 170. The gas release valve is a safety valve that releases a pressure in the container 100 when such a pressure is excessively increased. The solution filling portion is a portion for filling an electrolyte solution into the container 100 at the time of manufacturing the energy storage device 10.

The electrode terminals 300 are terminals (a positive electrode terminal 310 and a negative electrode terminal 320) that are electrically connected to the electrode assembly 700 via the current collectors 600.

That is, the electrode terminals 300 are metal-made members that are provided for discharging electricity stored in the electrode assembly 700 to an external space outside the energy storage device 10, and for charging electricity into an internal space in the energy storage device 10 so as to store electricity in the electrode assembly 700. Although a material of the electrode terminal 300 is not particularly limited, for example, the electrode terminals 300 (the positive electrode terminal 310 and the negative electrode terminal 320) are respectively formed of a conductive member made of aluminum, an aluminum alloy, copper, a copper alloy or the like. The electrode terminals 300 are connected (joined) to the current collectors 600 by caulking, welding or the like, and are mounted on the lid body 170. In this embodiment, the electrode terminal 300 includes a terminal body portion 330 and a shaft portion 340 that extends from the terminal body portion 330. The electrode terminal 300 may be a bolt terminal having a bolt portion that protrudes in the Z-axis direction and on which a male screw portion is formed.

The terminal body portion 330 is a portion that protrudes outward from a terminal mounting portion of the container 100. The terminal mounting portion is formed of the first upper surface 112, the first lower surface 114, the second upper surface 122, or the second lower surface 124. At any terminal mounting portion, the terminal body portion 330 protrudes outward from the container 100 along the Z-axis direction. Through holes 112a, 114a, 122a, and 124a through which the shaft portion 340 passes are formed in the lid body 170 at positions corresponding to the respective terminal mounting portions. The shaft portion 340 is connected (joined) to the current collector 600 by caulking in a state where the shaft portion 340 penetrates the terminal mounting portion, the outer gasket 400, the inner gasket 500 and the current collector 600. The positional relationship between the terminal body portion 330 and the respective recessed portions (the first recessed portion 101 and the second recessed portion 102) after joining will be described later.

The current collectors 600 are current collecting members (the positive electrode current collector 610 and the negative electrode current collector 620) having conductivity. The current collectors 600 are disposed in pair on both sides of the electrode assembly 700 in the X-axis direction. The current collectors 600 are connected (joined) to the electrode assembly 700 and the electrode terminals 300 so as to electrically connect the electrode assembly 700 and the electrode terminals 300 to each other. Specifically, the current collector 600 is an integral body formed of a first joint portion 630 that is connected (joined) to a tab portion 720 of the electrode assembly 700 described later by welding, caulking or the like; and a second joint portion 640 that is connected (joined) to the electrode terminal 300 by caulking, welding or the like as described above. The first joint portion 630 and the second joint portion 640 are each a flat plate-like portion. The first joint portion 630 and the second joint portion 640 are formed by bending one sheet metal. Although a material of the current collector 600 is not particularly limited, for example, the positive electrode current collector 610 is formed of a conductive member made of aluminum or an aluminum alloy or the like in the same manner as a positive electrode substrate 741 of the electrode assembly 700 described later, and the negative electrode current collector 620 is formed of a conductive member made of copper or a copper alloy or the like in the same manner as a negative electrode substrate 751 of the electrode assembly 700 described later.

The outer gasket 400 is a plate-like rectangular sealing member having insulating property that is disposed between the lid body 170 of the container 100 and the electrode terminal 300. The outer gasket 400 provides insulation and sealing between the lid body 170 and the electrode terminal 300. The inner gasket 500 is a plate-like rectangular sealing member having insulating property that is disposed between the lid body 170 and the current collector 600. The inner gasket 500 provides insulation and sealing between the lid body 170 and the current collector 600. The outer gasket 400 and the inner gasket 500 are made of a resin or the like having an electrically insulating material such as polypropylene (PP), polyethylene (PE), polystyrene (PS), a polyphenylene sulfide resin (PPS), polyphenylene ether (PPE (including modified PPE)), polyethylene terephthalate (PET), polybutylene terephthalate (PBT), polyether ether ketone (PEEK), tetrafluoroethylene/perfluoroalkyl vinyl ether (PFA), polytetrafluoroethylene (PTFE), polyether sulfone (PES), an ABS resin, or a composite material of the above-described materials.

The electrode assembly 700 is an energy storage element (a power generating element) that is formed by winding plates and can store electricity. The electrode assembly 700 has an elongated shape extending in the X-axis direction, and has an elongated circular shape as viewed in the X-axis direction. The electrode assembly 700 has a shape where a length in the X-axis direction is, for example, 300 mm or more, and more specifically, about 500 mm to 1500 mm. With such a configuration, the length of the electrode assembly 700 in the X-axis direction is set longer than the length of the electrode assembly 700 in the Z-axis direction. For example, the length of the electrode assembly 700 in the X-axis direction is 3 times or more as large as the length of the electrode assembly 700 in the Z-axis direction. The electrode assembly 700 includes the body portion 710 and a plurality of tab portions 720 protruding from the body portion 710. As described above, the tab portions 720 are connected (joined) to the current collectors 600. The tab portion 720 is an example of a connecting portion that is connected to the current collector 600.

Specifically, with respect to the plurality of tab portions 720, a pair of tab portions 720 protrudes from each of both end surfaces of the body portion 710 in the X-axis direction. For example, to one end surface of the body portion 710 in the X-axis positive direction, the positive electrode tab portion 721 is provided with a predetermined distance away from an end portion in the Z-axis positive direction, and the negative electrode tab portion 722 is provided with a predetermined distance away from an end portion in the Z-axis negative direction. On the other hand, to the other end surface of the body portion 710 in the X-axis negative direction, the negative electrode tab portion 722 is provided with a predetermined distance away from an end portion in the Z-axis positive direction, and the positive electrode tab portion 721 is provided with a predetermined distance away from an end portion in the Z-axis negative direction. That is, between the first end surface and the other end surface of the body portion 710, the positive electrode tab portion 721 and the negative electrode tab portion 722 are arranged in a reversed manner (upside down) as viewed in a direction along the winding axis (as viewed in the X-axis direction).

For example, in the case of an electrode assembly that is elongated in the X-axis direction and is configured such that positive electrode tab portions are provided only at one end portion of the electrode assembly in the X-axis direction and negative electrode tab portions are provided only at the other end portion of the electrode assembly in the X-axis direction, a distance between the positive electrode tab portions and the negative electrode tab portions becomes extremely long. Such a configuration is not preferable from a viewpoint that an electric resistance is increased and the occurrence of irregularities in reaction is induced. In the present embodiment, the positive electrode tab portion 721 and the negative electrode tab portion 722 are respectively provided to each of one end surface and the other end surface of the body portion 710 of the electrode assembly 700. Accordingly, a distance between the positive electrode tab portion 721 and the negative electrode tab portion 722 is shortened at each end surface of the body portion 710. As a result, the increase in an electric resistance and the occurrence of irregularities in reaction are suppressed. The configuration of such an electrode assembly 700 will be described in detail hereinafter.

### 2 Description of Configuration of Electrode Assembly 700

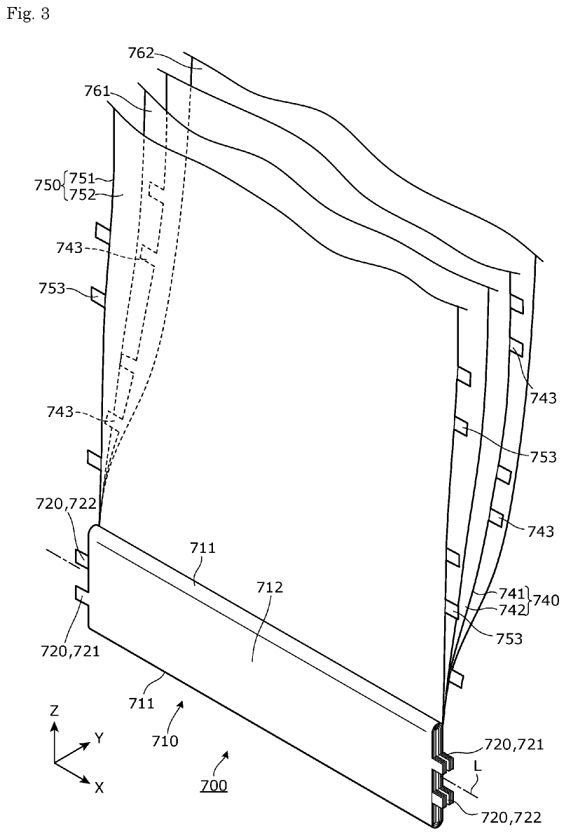

FIG. 3 is a perspective view illustrating the configuration of the electrode assembly 700 according to the embodiment 1. Specifically, FIG. 3 illustrates the configuration of the winding state of the plates in the electrode assembly 700 in a state where the winding state of the plates is partially developed. As illustrated in FIG. 3, the electrode assembly 700 includes a positive plate 740, a negative plate 750, and separators 761, 762.

The positive plate 740 is a plate (an electrode plate) that is formed such that a positive active material layer 742 is formed on a surface of the positive electrode substrate 741 that is an elongated strip-shaped metal foil made of aluminum or an aluminum alloy. The negative plate 750 is a plate (an electrode plate) that is formed such that a negative active material layer 752 is formed on a surface of the negative electrode substrate 751 that is an elongated strip-shaped metal foil made of copper or a copper alloy. As materials for forming the positive electrode substrate 741 and the negative electrode substrate 751, known materials such as nickel, iron, stainless steel, titanium, fired carbon, a conductive polymer, a conductive glass, and an Al—Cd alloy can be appropriately used provided that the materials are stable to an oxidation-reduction reaction during charging and discharging. As a positive active material used for forming the positive active material layer 742 and a negative active material used for forming the negative active material layer 752, known materials can be appropriately used provided that the materials are a positive active material and a negative active material capable of occluding and discharging lithium ions.

For example, as the positive active material, a polyanion compound such as LiMPO₄, LiMSiO₄, or LiMBO₃ (M representing one kind or two or more kinds of transition metal elements selected from Fe, Ni, Mn, Co, and the like), lithium titanate, a spinel-type lithium manganese oxide such as LiMn₂O₄ or LiMn_{1.5}Ni_{0.5}O₄, a lithium transition metal oxide such as LiMO₂ (M representing one kind or two or more kinds of transition metal elements selected from Fe, Ni, Mn, Co, and the like), or the like can be used. As the negative active material, besides lithium metal and a lithium alloy (lithium metal-containing alloys such as lithium-silicon, lithium-aluminum, lithium-lead, lithium-tin, lithium-aluminum-tin, lithium-gallium, and a wood's alloy), an alloy capable of occluding and releasing lithium, a carbon material (for example, graphite, non-graphitizable carbon, graphitizable carbon, low-temperature calcined carbon, amorphous carbon, and the like), a silicon oxide, a metal oxide, a lithium metal oxide (Li₄Ti₅O₁₂ or the like), a polyphosphoric acid compound, and a compound of transition metal and an element belong to any one of groups 14 to 16, such as Co₃O₄ or Fe₂P, that is generally referred to as a conversion negative electrode can be named.

The separators 761, 762 are each formed of a microporous sheet made of a resin. As a material of the separators 761 and 762, a known material can be appropriately used provided that the performance of the energy storage device 10 is not impaired. For example, as the separators 761 and 762, a woven fabric that is insoluble in an organic solvent, a nonwoven fabric, a synthetic resin microporous membrane made of a polyolefin resin such as polyethylene, or the like can be used.

The electrode assembly 700 is formed by alternately stacking and winding the positive plate 740, the negative plate 750, and the separators 761, 762. That is, the electrode assembly 700 is formed by stacking and winding the negative plate 750, the separator 761, the positive plate 740, and the separator 762 in this order. In the present embodiment, the electrode assembly 700 is a winding-type electrode assembly formed by winding the positive plate 740, the negative plate 750 and the like around the winding axis L extending in the X-axis direction. The winding axis L is a virtual axis that becomes a central axis when the positive plate 740, the negative plate 750 and the like are wound, and in the present embodiment, the winding axis L is a straight line which passes through the center of the electrode assembly 700 and is parallel to the X-axis direction.

On both end edges of the positive plate 740 in the winding axis direction, a plurality of protruding members 743 respectively protruding outward are disposed at intervals. In the same manner, on both end edges of the negative plate 750 in the winding axis direction, a plurality of protruding members 753 respectively protruding outward are disposed at intervals. In a state of the electrode assembly 700 after the stacking, the respective protruding members 743 of the positive plate 740 and the respective protruding members 753 of the negative plate 750 are alternately and repeatedly arranged by every two in the longitudinal direction of the positive plate 740 and the negative plate 750 respectively. Each of the protruding members 743 and 753 is a portion where the active material layer containing the active material is not formed and the substrate layer is exposed (an active material layer-non-formed portion).

When the positive plate 740, the negative plate 750, and the separators 761 and 762 are wound, the protruding members 743 of the positive plate 740 overlap with each other on one end surface of the body portion 710 and the protruding members 753 of the negative plate 750 overlap with each other on the other end surface of the body portion 710. A portion where the protruding members 743 of the positive plate 740 overlap with each other forms the positive electrode tab portion 721. That is, the positive electrode tab portion 721 is a portion formed by stacking a plurality of one members (protruding members 743) of the plates having the same polarity (the positive plates 740) out of the plurality of plates (the positive plate 740 and the negative plate 750).

In the same manner, a portion where the respective protruding members 753 of the negative plate 750 overlap with each other forms the negative electrode tab portion 722. That is, the negative electrode tab portion 722 is a portion formed by stacking a plurality of one members (protruding members 753) of the plates (the negative plates 750) having the same polarity out of the plurality of plates (the positive plate 740 and the negative plate 750).

As described above, the electrode assembly 700 includes: the body portion 710 that forms a body of the electrode assembly 700; and the plurality of tab portions 720 (the positive electrode tab portion 721 and the negative electrode tab portion 722) that protrude as a pair from both end surfaces of the body portion 710 in the X-axis direction respectively.

The body portion 710 is an elongated circular columnar portion (an active material layer forming portion) formed by winding portions of the positive plate 740 and the negative plate 750 where the positive active material layer 742 and the negative active material layer 752 are formed (coated) and the separators 761 and 762. With such a configuration, the body portion 710 has a pair of curved portions 711 on both sides in the Z-axis direction, and the body portion 710 has a flat portion 712 having a flat shape as a whole between the pair of curved portions 711. It can also be said that the pair of curved portions 711 is disposed at positions that interpose the flat portion 712 in the Z-axis direction.

Curved portions 711 are each formed of a portion having a curved shape that is curved in a semicircular arc shape so as to protrude in the Z-axis direction as viewed in the X-axis direction and extend in the X-axis direction. One curved portion 711 is disposed so as to face the bottom wall portion of the container body 160 and the other curved portion 711 is disposed so as to face the top wall portion of the lid body 170. That is, the pair of curved portions 711 is portions that is curved so as to protrude from the flat portion 712 toward the bottom wall portion of the container body 160 and the top wall portion of the lid body 170 as viewed in the X-axis direction, that is, toward both sides of the flat portion 712 in the Z-axis direction.

The flat portions 712 are portions having a rectangular flat shape that connect the end portions of the pair of curved portions 711 to each other and extend parallel to the XZ plane directed in the Y-axis direction. The flat portions 712 are disposed so as to face the long side wall portions of the container body 160 on both sides in the Y axis direction. The flat portion 712 is a main portion of the electrode assembly 700. In the flat portion 712, a plurality of wound plates (the positive plate 740 and the negative plate 750) are stacked in the Y-axis direction. That is, in the flat portion 712, the Y-axis direction is a stacking direction of the plurality of plates. As described above, the flat portion 712 is a main portion of the electrode assembly 700 and hence, a main stacking direction of the electrode assembly 700 is defined as the Y-axis direction in the present disclosure.

The curved shape of the curved portion 711 is not limited to a semicircular arc shape, and may be a part of an elliptical shape or the like. That is, the curved shape may be curved in any shape. The flat portion 712 is not limited to a shape where an outer surface of the flat portion 712 directed in the Y-axis direction is a flat surface, and the outer surface may be slightly recessed or may be slightly bulged.

### 3 Positional Relationship Between Terminal Body Portion, Respective Recessed Portions, Electrode Assembly, and Current Collectors

Next, the positional relationship between the terminal body portion 330, the respective recessed portions (the first recessed portions 101 and the second recessed portions 102), the electrode assembly 700, and the current collectors 600 is described. In this embodiment, the explanation is made by illustrating the first recessed portion 101 and the second recessed portion 102 of the first side surface portion 110 as an example. However, the second side surface portion 120 adopts substantially the same configuration and hence, the explanation of the second side surface portion 120 is omitted.

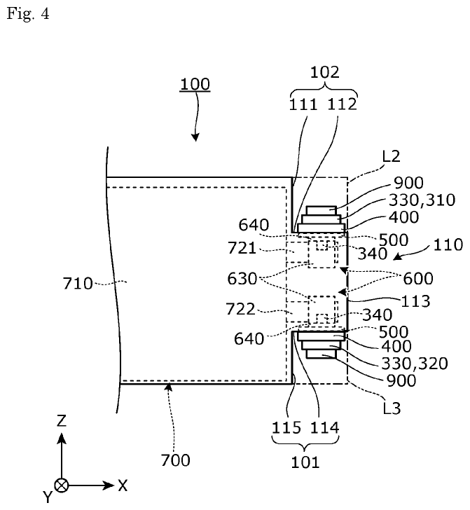

FIG. 4 is a plan view illustrating the first side surface portion 110 according to the embodiment 1. Also in FIG. 4, a rectangular parallelepiped shape of the container 100 that is used as a reference is indicated by a double-dashed chain lines L2, L3. Accordingly, the “inside of the first recessed portion 101” means the inside of a region that is defined by a profile having a rectangular parallelepiped shape (double-dashed chain line L2) that is used as the reference, the first lower surface 114, and the first lower side surface 115. In the same manner, the “inside of the second recessed portion 102” means the inside of a region defined by a profile having a rectangular parallelepiped shape (double-dashed chain line L3) that is used as the reference, the first upper side surface 111, and the first upper surface 112.

In this embodiment, the negative electrode terminal 320 disposed in the first recessed portion 101 is an example of a second terminal, and the first lower surface 114 on which the second terminal is mounted is an example of a second terminal mounting portion. On the other hand, the positive electrode terminal 310 disposed in the second recessed portion 102 is an example of a first terminal, and the first upper surface 112 on which the first terminal is mounted is an example of the first terminal mounting portion.

FIG. 4 illustrates a state where a bus bar 900 is joined to respective terminal body portions 330. The bus bars 900 are plate-like conductive members extending in the Y-axis direction, and are joined to the electrode terminals 300 of other energy storage devices.

As illustrated in FIG. 4, in the second recessed portion 102, the terminal body portion 330 of the positive electrode terminal 310 is mounted on the first upper surface 112 that forms the first terminal mounting portion in a protruding manner outward by way of the outer gasket 400. In this state, the entirety of the terminal body portion 330 of the positive electrode terminal 310 is accommodated in the second recessed portion 102 as viewed in the Y-axis direction. That is, the terminal body portion 330 of the positive electrode terminal 310 is disposed below the top surface 140 as a whole. Further, the entirety of the bus bar 900 joined to the positive electrode terminal 310 is also accommodated in the second recessed portion 102 and is disposed below the top surface 140 as viewed in the Y-axis direction.

In the first side surface portion 110, the positive electrode tab portion 721 and the negative electrode tab portion 722 of the electrode assembly 700 in the X-axis positive direction are disposed between the first recessed portion 101 and the second recessed portion 102. With such a configuration, the positive electrode tab portion 721 and the negative electrode tab portion 722 are disposed at positions that are retracted from the portions which form the first upper side surface 111 and the first lower side surface 115 respectively. Accordingly, the body portion 710 of the electrode assembly 700 can be disposed close to the portions which form the first upper side surface 111 and the first lower side surface 115 respectively. Accordingly, it is possible to form the body portion 710 that is a portion contributing to the storage of power (generation of power) as large as possible.

The current collector 600 joined to the positive electrode tab portion 721 extends in the Z-axis direction in a space that overlaps with the first upper surface 112 when the first upper surface 112 that forms the terminal mounting surface is viewed in a plan view. Specifically, the first joint portion 630 of the current collector 600 joined to the positive electrode tab portion 721 is a plate-like portion extending in the Z-axis direction, and is joined to the positive electrode tab portion 721. The second joint portion 640 of the current collector 600 is a plate-like portion bent from an upper end of the first joint portion 630, and is joined to the shaft portion 340 of the positive electrode terminal 310. The first joint portion 630 and the second joint portion 640 are accommodated in a space that overlaps with the first upper surface 112 when the first upper surface 112 is viewed in a plan view. That is, the first joint portion 630 and the positive electrode tab portion 721 are joined to each other in the space in a state where the current collector 600 does not protrude from the space, and the joining structure of these constitutional elements also does not protrude from the space.

On the other hand, in the first recessed portion 101, the terminal body portion 330 of the negative electrode terminal 320 is mounted on the first lower surface 114 that forms the second terminal mounting portion in a protruding manner outward by way of the outer gasket 400. In this state, the entirety of the terminal body portion 330 of the negative electrode terminal 320 is accommodated in the first recessed portion 101 as viewed in the Y-axis direction. That is, the terminal body portion 330 of the negative electrode terminal 320 is disposed above the bottom surface 150 as a whole. Further, the entirety of the bus bar 900 joined to the negative electrode terminal 320 is also accommodated in the first recessed portion 101 as viewed in the Y-axis direction, and is disposed above the bottom surface 150.

As descried previously, the second side surface portion 120 also has substantially the same configuration as the first side surface portion 110. Accordingly, the terminal body portion 330 and the bus bar 900 in each of the second recessed portions 102 are disposed below the top surface 140 and do not protrude from the top surface 140. In the same manner, the terminal body portion 330 and the bus bar 900 in each of the first recessed portions 101 are disposed above the bottom surface 150 and do not protrude from the bottom surface 150. On the second side surface portion 120, the positive electrode terminal 310 disposed in the first recessed portion 101 is an example of a second terminal, and the second lower surface 124 on which the second terminal is mounted is an example of a second terminal mounting portion. On the other hand, on the second side surface portion 120, the negative electrode terminal 320 disposed in the second recessed portion 102 is an example of a first terminal, and the second upper surface 122 on which the first terminal is mounted is an example of a first terminal mounting portion.

The current collector 600 joined to the negative electrode tab portion 722 extends in the Z-axis direction in a space that overlaps with the first lower surface 114 when the first lower surface 114 that forms the terminal mounting surface is viewed in a plan view. Specifically, the first joint portion 630 of the current collector 600 joined to the negative electrode tab portion 722 is a plate-like portion extending in the Z-axis direction, and is joined to the negative electrode tab portion 722. The second joint portion 640 of the current collector 600 is a plate-like portion bent from an upper end of the first joint portion 630, and is joined to the shaft portion 340 of the negative electrode terminal 320. The first joint portion 630 and the second joint portion 640 are accommodated in a space that overlaps with the first lower surface 114 when the first lower surface 114 is viewed in a plan view. That is, the first joint portion 630 and the negative electrode tab portion 722 are joined to each other in the space in a state where the current collector 600 does not protrude from the space, and the joining structure of these constitutional elements also does not protrude from the space. As described above, also the joining structure between the positive electrode tab portion 721 and the current collector 600 does not protrude from the space and hence, the body portion 710 of the electrode assembly 700 can be disposed as large as possible.

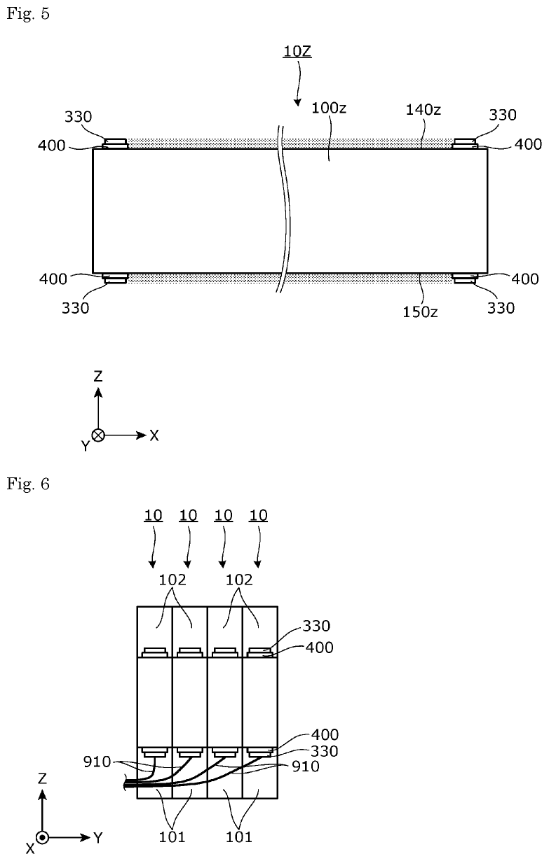

FIG. 5 is a plan view schematically illustrating an energy storage device 10Z according to a comparative example. As illustrated in FIG. 5, in the energy storage device 10Z, a container 100z has neither first recessed portions nor second recessed portions. That is, the container 100z is formed in a rectangular parallelepiped shape. Accordingly, in the comparative example, a pair of electrode terminals 300 is mounted on a top surface 140z of the container 100z, and a pair of electrode terminals 300 is also mounted on a bottom surface 150z. In the top surface 140z of the energy storage device 10z of the comparative example, the pair of electrode terminals 300 protrudes from the top surface 140z and hence, a space between the pair of electrode terminals 300 becomes a surplus space (a dotted hatching portion in FIG. 5). In the same manner, on the bottom surface 150z, the pair of electrode terminals 300 protrudes from the bottom surface 150z and hence, a space between the pair of electrode terminals 300 becomes a surplus space.

On the other hand, in this embodiment, the terminal body portion 330 in each of the second recessed portions 102 does not protrude from the top surface 140 and hence, a surplus space outside the container 100 is reduced between the pair of electrode terminals 300 disposed on the upper portion of the container 100 (see FIG. 4). In the same manner, also between the pair of electrode terminals 300 disposed on the lower portion of the container 100, a surplus space outside the container 100 is reduced. That is, by reducing a surplus space outside the container 100, an internal space of an outer case that accommodates the energy storage devices 10 can be efficiently utilized.

### 4 Description of Advantageous Effects

As described above, in the energy storage device 10 according to this embodiment, the first recessed portion 101 is formed on each of the first side surface portion 110 and the second side surface portion 120 at a position different from the first terminal mounting portion (the first upper surface 112 and the second upper surface 122). Accordingly, members other than the energy storage device 10 (such as wires for measuring voltages or temperatures) can be disposed in the first recessed portion 101. FIG. 6 is an explanatory view illustrating a state where wires 910 for measuring voltages are mounted in the first recessed portion 101 according to the embodiment 1. FIG. 6 illustrates a state where the plurality of energy storage devices 10 are arranged in the Y-axis direction. In each energy storage device 10, the wire 910 for measuring a voltage is joined (connected) to the terminal body portion 330 of the electrode terminal 300 disposed in the first recessed portion 101. The wire 910 is provided for each energy storage device 10, and each wire 910 is disposed in the first recessed portion 101 of the energy storage device 10, and the wires 910 are pulled out to the outside of the plurality of energy storage devices 10. In this manner, each wire 910 can be arranged in the first recessed portion 101 and hence, it is possible to suppress the lowering of the space utilization efficiency outside the energy storage device 10. In this embodiment, the space utilization efficiency means the degree of effective use of a space where the energy storage device 10 and the members other than the energy storage device 10 are disposed. When a surplus space is large, the degree of effective use is low and hence, the space utilization efficiency is also lowered.

On each of the first side surface portion 110 and the second side surface portion 120, a first terminal mounting portion (a first upper surface 112, a second upper surface 122) is disposed at one end portion in the second direction (an end portion in the Z-axis positive direction). With such a configuration, a conductive member such as the bus bar 900 can be easily joined to the first terminal disposed on the first terminal mounting portion from the Z-axis positive direction. On the other hand, with respect to the respective side surface portions, the first recessed portion 101 is disposed on the other end portion in the second direction (an end portion on the Z-axis negative direction). Accordingly, the first recessed portion 101 can be formed in a shape where the end portion in the Z-axis negative direction is opened. Accordingly, the open region of the first recessed portion 101 expands and hence, the members other than the energy storage device 10 can be easily disposed in the first recessed portion 101. In this manner, operability of the energy storage device 10 with respect to the members around the energy storage device 10 can be enhanced.

The first terminal mounting portion (the first upper surface 112, the second upper surface 122) is disposed in the second recessed portion 102 formed in each of the first side surface portion 110 and the second side surface portion 120, the entirety of the first terminal can be disposed in the second recessed portion 102. With such a configuration, the energy storage device accommodating space outside the container can be reduced. Accordingly, it is possible to, more efficiently, suppress the lowering of the space utilization efficiency of the outside of the energy storage device.

The second terminal mounting portion (the first lower surface 114, the second lower surface 124) is disposed in the first recessed portion 101 formed on each of the first side surface portion 110 and the second side surface portion 120. Accordingly, at least a portion of the second terminal can be disposed in the first recessed portion 101. With such a configuration, the energy storage device accommodating space outside the container can be reduced. Accordingly, it is possible to suppress the lowering of the space utilization efficiency outside the energy storage device.

For example, assume an electrode assembly elongated in the first direction (X-axis direction), when the positive electrode terminal is disposed only at one end portion of the electrode assembly in the first direction, and the negative electrode terminal is disposed only at the other end portion of the electrode assembly in the first direction, a distance between the positive electrode terminal and the negative electrode terminal becomes extremely long. Such a configuration is not preferable from a viewpoint that an electric resistance is increased and the occurrence of irregularities in reaction is induced. In the present embodiment, the longitudinal direction (Z-axis direction) of each side surface portion of the container 100 is shorter than the length of the electrode assembly 700 in the first direction. Accordingly, even if the first terminal (one of the positive electrode terminal 310 and the negative electrode terminal 320) and the second terminal (the other of the positive electrode terminal 310 and the negative electrode terminal 320) having different polarities are disposed on each side surface portion, the distance between the terminals can be shortened. That is, in this embodiment, the distance between the first terminal and the second terminal having different polarities can be shortened and hence, the increase in electric resistance and the occurrence of irregularities in reaction can be suppressed.

Further, the first terminal and the second terminal disposed on each side surface portion have different polarities. Accordingly, it is also possible to increase the degree of freedom of the electrical connection structure between the energy storage devices 10 when the plurality of energy storage devices 10 are arranged in the Y axis direction.

The pair of connecting portions (the positive electrode tab portion 721 and the negative electrode tab portion 722) is disposed in each of the first side surface portion 110 and the second side surface portion 120. Accordingly, the body portion 710 of the electrode assembly 700 can be formed as large as possible between the first side surface portion 110 and the second side surface portion 120 of the container 100. The body portion 710 is a portion that contributes to the storage of energy (generation of power) and hence, the electric capacitance of the energy storage device 10 can be increased by forming the body portion 710 largely.

### 5 Description of Modifications

Hereinafter, respective modifications of the above-mentioned embodiment 1 will be described. In the following description, components equivalent to the components in the above-mentioned embodiment 1 or other modifications are denoted by the same reference numerals, and the description of these components may be omitted. In the following description, the first side surface portion will be described as an example. However, the second side surface portion also has substantially the same shape as the first side surface portion.

### Modification 1

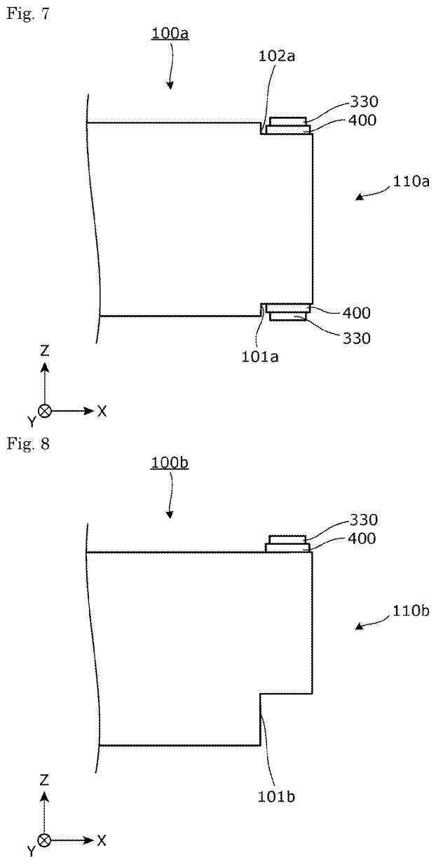

The modification 1 of the above-mentioned embodiment 1 will be described. FIG. 7 is a plan view illustrating a first side surface portion 110a according the modification 1 of the embodiment 1. In the above-mentioned embodiment 1, the case is exemplified where the entirety of the terminal body portion 330 of each electrode terminal 300 is accommodated in the respective recessed portions (the first recessed portions 101 and the second recessed portions 102). In the modification 1, the description will be made with respect to a case where a portion of the terminal body portion 330 of each electrode terminal 300 is disposed in the respective recessed portions.

As illustrated in FIG. 7, in the first side surface portion 110a, only an end portion of the terminal body portion 330 in the Z-axis positive direction protrudes from the second recessed portion 102a, and other portions of the terminal body portion 330 are accommodated in the second recessed portion 102a. That is, as compared with the comparative example, a protruding amount of the terminal body portion 330 from a top surface 140a of a container 100a is suppressed. Accordingly, it is possible to reduce an energy storage device accommodating space outside an upper portion of the container 100a.

Further, in the first side surface portion 110a, only an end portion of the terminal body portion 330 in the Z-axis negative direction protrudes from the first recessed portion 101a from the first recessed portion 101a, and other portions of the terminal body portion 330 are accommodated in the first recessed portion 101a. That is, as compared with the comparative example, a protruding amount of the terminal body portion 330 from a bottom surface 150a of the container 100a is suppressed. Accordingly, it is possible to reduce the energy storage device accommodating space outside a lower portion of the container 100a attributed to the electrode terminal 300.

### Modification 2

Next, a modification 2 of the above-mentioned embodiment 1 will be described. In the embodiment 1, the first side surface portion 110 that includes the first recessed portion 101 and the second recessed portion 102 has been exemplified. However, in this modification 2, the description will be made with respect to the first side surface portion 110b that includes only the first recessed portion 101b.

FIG. 8 is a plan view illustrating a first side surface portion 110b according to a modification 2 of the embodiment 1. As illustrated in FIG. 8, on the first side surface portion 110b according to the modification 2, a first recessed portion 101b is formed. However, a second recessed portion is not formed on the first side surface portion 110b. In this case, a terminal body portion 330 of an electrode terminal 300 and an outer gasket 400 are disposed on a top surface 140b of a container 100b. As described above, also in the container 100b according to the modification 2, a member other than the energy storage device can be accommodated in the first recessed portion 101b. Accordingly, the lowering of the space utilization efficiency outside the energy storage device can be suppressed.

### Modification 3

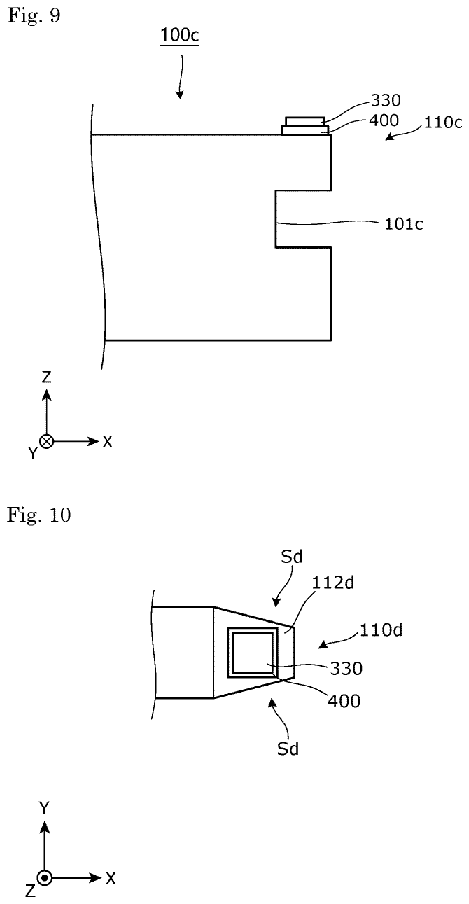

Next, a modification 3 of the above-mentioned embodiment 1 will be described. Also with respect to the modification 3, a first side surface portion 110c having only a first recessed portion 101c will be described. The modification 3 differs from the modification 2 with respect to a position where the first recessed portion 101c is formed. FIG. 9 is a plan view illustrating a first side surface portion 110c according to the modification 3 of the embodiment 1. As illustrated in FIG. 9, on the first side surface portion 110c according to the modification 3, the first recessed portion 101c is formed at an intermediate portion in the Z-axis direction. The first recessed portion 101c is a rectangular cutout where only an end portion in the X-axis positive direction is opened.

Also in the container 100c according to the modification 3, a member other than the energy storage device can be accommodated in the first recessed portion 101c. Accordingly, the lowering of the space utilization efficiency outside the energy storage device can be suppressed.

### Modification 4

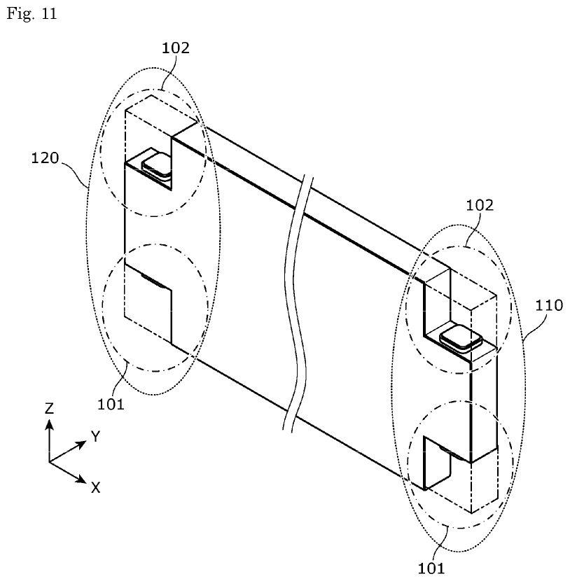

Next, a modification 4 of the above-mentioned embodiment 1 will be described. FIG. 10 is a top plan view illustrating a first side surface portion 110d according to the modification 4 of the embodiment 1. In the above-mentioned embodiment 1, the case is exemplified where the first upper surface 112 and the first lower surface 114 of the first side surface portion 110 have a rectangular shape as viewed in a plan view (as viewed in the Z-axis direction). In the modification 4, a case will be exemplified where the first upper surface 112d and the first lower surface (not illustrated) have a trapezoidal shape as viewed in a plan view (as viewed in the Z-axis direction). In FIG. 10, although only the first upper surface 112d is illustrated, the first lower surface also has substantially the same shape as the first upper surface 112d.

As illustrated in FIG. 10, the first upper surface 112d has a trapezoidal shape where a distal end portion (an end portion in the X-axis positive direction) has a width (a width in the Y-axis direction) narrower than a width (a width in the Y-axis direction) of a proximal end portion (an end portion in the X-axis negative direction). That is, the first upper surface 112d has a tapered shape as viewed in the Z-axis direction. As described above, the first lower surface also has substantially the same shape as the first upper surface 112d and hence, it may be expressed that the first side surface portion 110d also has a tapered shape as viewed in the Z-axis direction. So long as the first side surface portion 110d is tapered as viewed in the Z-axis direction, the first upper surface 112d and the first lower surface may have a shape other than a trapezoidal shape (for example, a triangular shape or the like) as viewed in plan view.

In this manner, the first side surface portion 110d has the tapered shape as viewed in the Z-axis direction and hence, a space Sd can be formed on each of the sides of the first side surface portion 110d in the lateral direction (the Y-axis direction). In the spaces Sd, members (for example, wires and the like) other than the energy storage device 10 can be disposed and hence, the space utilization efficiency of the energy storage device can be enhanced.

### Embodiment 2

In the above-mentioned embodiment 1, the energy storage device 10 is exemplified where the electrode terminal 300 is disposed in each of the first recessed portion 101 and the second recessed portion 102 formed on the first side surface portion 110, and the electrode terminal 300 is disposed in each of the first recessed portion 101 and the second recessed portion 102 formed on the second side surface portion 120. In the embodiment 2, an energy storage device is described where an electrode terminal is disposed only in a second recessed portion with respect to a first side surface portion, and an electrode terminal is disposed only in a second recessed portion also with respect to a second side surface portion. In the following description, components equivalent to the components in the embodiment 1 are denoted by the same reference numerals, and the description of these components may be omitted.

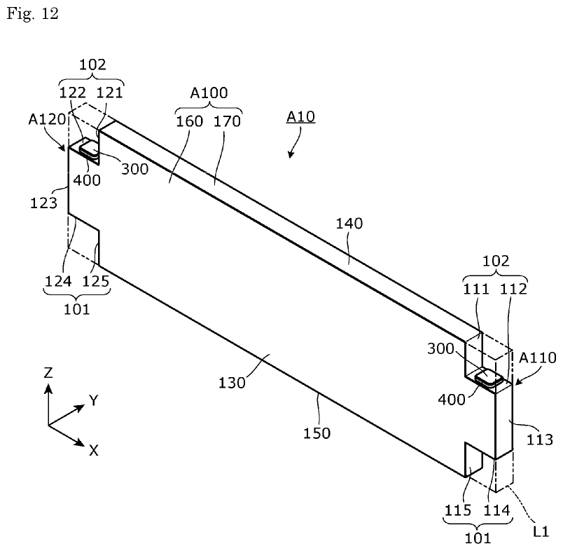

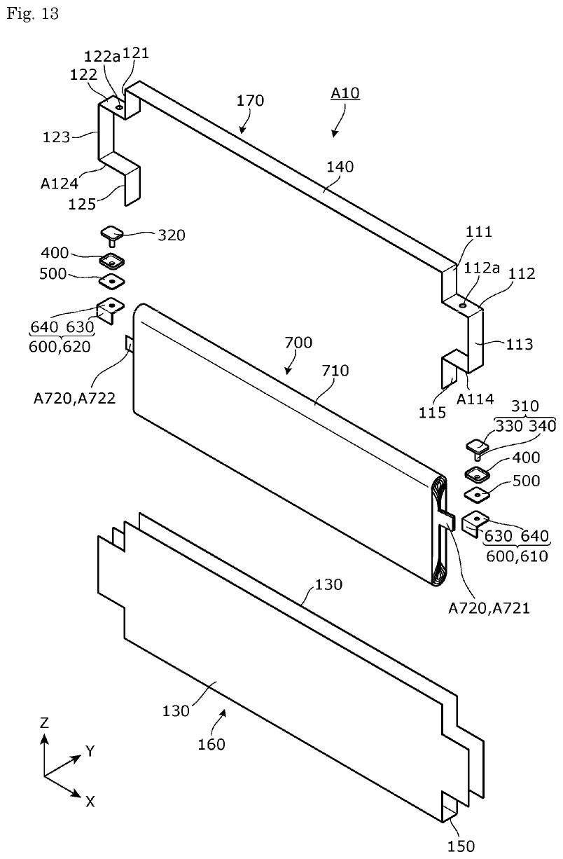

FIG. 12 is a perspective view illustrating an external appearance of an energy storage device A10 according to an embodiment 2. FIG. 13 is an exploded perspective view of the energy storage device A10 according to the embodiment 2 illustrating respective constitutional elements in a state where the energy storage device A10 is disassembled.

As illustrated in FIG. 12 and FIG. 13, the energy storage device A10 includes: a container A100; a pair of electrode terminals 300, and a pair of outer gaskets 400. A pair of inner gaskets 500, a pair of current collectors 600, and an electrode assembly 700 are accommodated in the container A100. On a first side surface portion A110 of the container A100 in the X-axis positive direction, respective members of a positive electrode are disposed. On a second side surface portion A120 of the container 100 in the X-axis negative direction, respective members of a negative electrode are disposed.

Out of the pair of electrode terminals 300, the positive electrode terminal 310 is disposed in a second recessed portion 102 formed on the first side surface portion A110. Specifically, a terminal body 330 of the positive electrode terminal 310 is mounted on a first upper surface 112 that forms the second recessed portion 102 formed on the first side surface portion A110. A through hole 112a through which a shaft portion 340 of the positive electrode terminal 310 passes is formed in the first upper surface 112. However, a through hole is not formed in a first lower surface A114.

Out of the pair of electrode terminals 300, the negative electrode terminal 320 is disposed in the second recessed portion 102 formed on a second side surface portion A120. Specifically, a terminal body 330 of the negative electrode terminal 320 is mounted on a second upper surface 122 that forms the second recessed portion 102 formed on the second side surface portion A1210. A through hole 122a through which a shaft portion of the negative electrode terminal 320 passes is formed in the second upper surface 122. However, a through hole is not formed in a second lower surface A124.

The electrode assembly A700 is an energy storage element (power generating element) that is formed by winding plates and can store electricity. In an electrode assembly A700, one tab portion A720 protrudes from each of both end surfaces of the body portion 710 in the X-axis direction. On one end surface of the body portion 710 in the X-axis positive direction, a positive electrode tab portion A721 is disposed in a spaced apart manner from an end portion in the Z-axis positive direction by a predetermined distance. The positive electrode terminal 310 is joined to the positive electrode tab portion A721 via a current collector 600.

On the other hand, on the other end surface of the body portion 710 in the X-axis negative direction, a negative electrode tab portion A722 is disposed in a spaced apart manner from an end portion in the Z-axis positive direction by a predetermined distance. The negative electrode terminal 320 is joined to the negative electrode tab portion A722 via the current collector 600.

Also in such an energy storage device A10, on each of the first side surface portion A110 and the second side surface portion A120, a first recessed portion 101 is formed at a position different from a first terminal mounting portion (the first upper surface 112, the second upper surface 122). Accordingly, a member other than the energy storage device A10 (such as a wire for measuring a voltage or a temperature) can be disposed in the first recessed portion 101. In this manner, the member other than the energy storage device A10 can be disposed in the first recessed portion 101 and hence, the lowering of space utilization efficiency outside the energy storage device A10 can be suppressed.

### Embodiment 3

In the energy storage device 10 according to the above-mentioned embodiment 1, the case is exemplified where the first recessed portion 101 and the second recessed portion 102 are formed on each of the first side surface portion 110 and the second side surface portion 120 of the container 100. In the embodiment 3, a case is described where a first recessed portion and a second recessed portion are formed only on a first side surface portion of a container. In the following description, components equivalent to the components in the embodiment 1 are denoted by the same reference numerals, and the description of these components may be omitted.

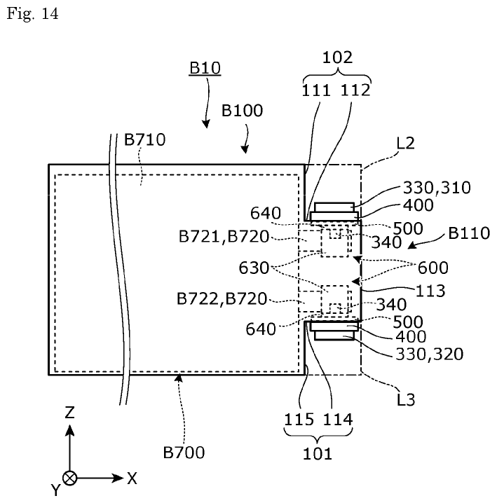

FIG. 14 is a schematic plan view illustrating an energy storage device B10 according to the embodiment 3. As illustrated in FIG. 14, in a container B100 of the energy storage device B10, the first recessed portion 101 and the second recessed portion 102 are formed on a first side surface portion B110. On the other hand, an end portion of the container B100 in the X-axis negative direction is formed in a flat shape as a whole. Specifically, an end portion of the container B100 in the X-axis negative direction is a flat surface parallel to the YZ plane extending from an end portion in the Z-axis positive direction to an end portion in the Z-axis negative direction.

In the electrode assembly B700 accommodated in the container B100, a pair of tab portions B720 are formed on only one end portion of the electrode assembly B700 in the winding axis direction. Specifically, on one end surface of the body portion B710 of the electrode assembly 700B in the X-axis direction, positive electrode tab portions B721 are formed at a predetermined interval from an end portion in the Z-axis positive direction, and negative electrode tab portions B722 are formed at a predetermined interval from an end portion in the Z-axis negative direction. The positive electrode tab portion B721 and the negative electrode tab portion B722 are disposed in a space formed between the first recessed portion 101 and the second recessed portion 102 on the first side surface portion B110. On the other hand, tab portions do not protrude from the other end surface of the body portion B710 of the electrode assembly 700B in the X-axis direction. Accordingly, the body portion B710 can be disposed as close as possible to the end portion of the container B100 in the X-axis negative direction.

In the energy storage device B10 according to this embodiment, on the first side surface portion B110, the first recessed portion 101 is disposed at a position different from a first terminal mounting portion (a first upper surface 112). Accordingly, a member other than the energy storage device B10 (such as a wire for measuring a voltage or a temperature) can be disposed in the first recessed portion 101. In this manner, the member other than the energy storage device B10 can be disposed in the first recessed portion 101 and hence, the lowering of space utilization efficiency outside the energy storage device B10 can be suppressed.

### Other Modifications

Although the energy storage device according to the embodiment of the present invention (including the modifications of the embodiment, the same understanding being adopted in the description made hereinafter) has been described heretofore, the present invention is not limited to the embodiment and modifications described above. That is, the embodiments disclosed this time are illustrative in all aspects. The present invention includes all alterations which fall within the scope of claims or are considered equivalent to the present invention called for in claims.

For example, in the embodiment 1 and the like described above, the case where only one electrode assembly 700 is accommodated in the container 100 has been exemplified. However, a plurality of electrode assemblies may be accommodated in the container.

In the embodiment 1 and the like described above, the case is exemplified where the positive electrode tab portion 721 and the negative electrode tab portion 722 are disposed in a reversed manner (vertically upside down) as viewed in the X-axis direction on one end surface and the other end surface of the body portion 710 of the electrode assembly 700. However, the positive electrode tab portion 721 and the negative electrode tab portion 722 may not be disposed in a reversed manner.

In the above-mentioned embodiment 1 and the like, the winding-type electrode assembly 700 is exemplified as an example of the electrode assembly formed by stacking a plurality of plates. However, besides the above-mentioned winding-type electrode, the electrode assembly where the plurality of plates are stacked includes: a stacking type electrode assembly where flat plate-shaped electrode plates are stacked; and an electrode assembly where plates and/or separators are folded in a bellows shape (a mode where the separator is folded in a bellows shape so as to interpose plates having a rectangular shape, a mode where the plates and the separators are made to overlap with each other and, thereafter, these plates and the separators are folded in a bellows shape and the like). In all cases, it is sufficient that the stacking direction of the electrode assembly be set to the Y-axis direction. For example, even in the case of a non-winding-type electrode assembly such as a stacking type electrode assembly, a profile of the electrode assembly is formed in a shape that corresponds to the profile of the electrode assembly 700 illustrated in FIG. 4, FIG. 14 or the like. In this case, an upper end portion and the other end portion of the non-winding type electrode assembly have a planar shape.

In the above-mentioned embodiment 1 and the like, the case is exemplified where the first recessed portion 101 is disposed at the same position in the first side surface portion 110 and the second side surface portion 120. However, the first recessed portion 101 may be disposed at different positions between the first side surface portion 110 and the second side surface portion 120. Alternatively, the first recessed portion 101 may be formed only in one of the first side surface portion 110 and the second side surface portion 120.

The configurations that are formed by arbitrarily combining the respective constituent elements that the embodiments and the modification examples described above include also fall within the scope of the present invention.

### INDUSTRIAL APPLICABILITY

The present invention is applicable to an energy storage device such as a lithium ion secondary battery or the like.

### DESCRIPTION OF REFERENCE SIGNS

10, A10, B10, 10Z: energy storage device
100, 100a, A100, 100b, B100, 100c, 100z: container
101, 101a, 101b, 101c: first recessed portion
102, 102a: second recessed portion
110, 110a, A110, 110b, B110, 110c, 110d: first side surface portion (side surface portion)
111: first upper side surface
112, 112d: first upper surface (first terminal mounting portion)
113: first intermediate side surface
114, A114: first lower surface (second terminal mounting portion)
115: first lower side surface
120, A120: second side surface portion (side surface portion)
121: second upper side surface
122: second upper surface (first terminal mounting portion)
123: second intermediate side surface
124, A124: second lower surface (second terminal mounting portion)
125: second lower side surface
130: long side surface
140, 140a, 140b, 140z: top surface
150, 150a, 150z: bottom surface
160: container body
170: lid body
310: positive electrode terminal (first terminal or second terminal)
320: negative electrode terminal (first terminal or second terminal)
330: terminal body portion
340: shaft portion
610: positive electrode current collector
620: negative electrode current collector
630: first joint portion
640: second joint portion
700: electrode assembly
720, A720, B720: connecting portion
740: positive plate (plate)
750: negative plate (plate)
900: bus bar
910: wire
L: winding axis

1. An energy storage device comprising:
an electrode assembly comprising a plurality of plates and elongated in a first direction;
a container configured to accommodate the electrode assembly and elongated in the first direction; and
a first terminal is configured to be electrically connected to the electrode assembly,
wherein the container includes a side surface portion at an end portion of the container in the first direction, such that the side surface portion includes a first terminal mounting portion on which the first terminal is mounted, and a first recessed portion is formed at a position different from a position where the first terminal mounting portion is disposed.

2. The energy storage device according to claim 1, wherein the side surface portion of the container is elongated in a second direction that intersects with the first direction, the first terminal mounting portion in the side surface portion of the container is disposed at one end portion of the side surface portion in the second direction, and the first recessed portion in the side surface portion of the container is disposed at an other end portion of the side surface portion in the second direction.

3. The energy storage device according to claim 1, wherein the side surface portion of the container is formed such that the first terminal mounting portion is disposed in a second recessed portion formed at a position different from a position where the first recessed portion is disposed on the side surface portion.

4. The energy storage device according to claim 1, further comprising:
a second terminal is configured to be electrically connected to the electrode assembly, and mounted on a second terminal mounting portion disposed in the first recessed portion in the side surface portion of the container.

5. The energy storage device according to claim 4, wherein the first terminal and the second terminal disposed on the side surface portion have different polarities.

6. The energy storage device according to claim 1, wherein the electrode assembly includes an electrode assembly body, and a pair of connecting portions protruding from one end portion of the electrode assembly body in the first direction; and disposed within the side surface portion of the container.

7. The energy storage device according to claim 2, wherein the side surface portion of the container is formed such that the first terminal mounting portion is disposed in a second recessed portion formed at a position different from a position where the first recessed portion is disposed on the side surface portion.

8. The energy storage device according to claim 2, further comprising:
a second terminal configured to be electrically connected to the electrode assembly and mounted on a second terminal mounting portion disposed in the first recessed portion in the side surface portion of the container.

9. The energy storage device according to claim 8, wherein the first terminal and the second terminal disposed on the side surface portion have different polarities.

10. The energy storage device according to claim 2, wherein the electrode assembly includes an electrode assembly body, and a pair of connecting portions protruding from one end portion of the electrode assembly body in the first direction and disposed within the side surface portion of the container.

11. The energy storage device according to claim 3, further comprising:
a second terminal configured to be electrically connected to the electrode assembly and mounted on a second terminal mounting portion disposed in the first recessed portion in the side surface portion of the container.

12. The energy storage device according to claim 11, wherein the first terminal and the second terminal disposed on the side surface portion have different polarities.

13. The energy storage device according to claim 3, wherein the electrode assembly includes an electrode assembly body, and a pair of connecting portions protruding from one end portion of the electrode assembly body in the first direction and disposed within the side surface portion of the container.

14. The energy storage device according to claim 4, wherein the electrode assembly includes an electrode assembly body, and a pair of connecting portions protruding from one end portion of the electrode assembly body in the first direction and disposed within the side surface portion of the container.

15. The energy storage device according to claim 5, wherein the electrode assembly includes an electrode assembly body, and a pair of connecting portions protruding from one end portion of the electrode assembly body in the first direction and disposed within the side surface portion of the container.
